(19) United States
(12) Patent Application Publication
(10) Pub. No.: US 2018/0255764 A1
(43) Pub. Date: Sep. 13, 2018

(54) SYSTEM FOR SUSPENDING A DECOY

(71) Applicant: Flint Holdings, LLC, Hummelstown, PA (US)

(72) Inventor: Carroll J. Davis, Edgefield, SC (US)

(21) Appl. No.: 15/451,956

(22) Filed: Mar. 7, 2017

(51) Int. Cl. A01M 31/06; E04H 12/22; A45F 3/44; F16B 2/20

(52) U.S. Cl. CPC A01M 31/06; F16B 2/20; A45F 3/44; E04H 12/2215

(57) ABSTRACT

A device for suspending a decoy comprising an extendable rod including a first tubular section with a first end and a second end, wherein the first end is configured to connect to a mounting post and the second end includes an open end from which extends a plurality of flexible tubular sections where the sections have progressively smaller diameters, are slidably disposed in one another, and are in tight frictional engagement with each other such that they remain in any position of extension or retraction in which they are set, and wherein when the extendable rod is in an extended position the plurality of flexible tubular sections are sufficiently flexible that a weight of the decoy causes the plurality of tubular sections to bend and position the decoy proximate to the ground when the extendable rod is in a deployed position.

### FIELD OF THE INVENTION

The present invention relates to portable mechanisms for suspending animal decoys. When suspended, light-weight decoys move in response to the wind, thus appearing more lifelike.

### BACKGROUND

Animal decoys may be used to attract animals and to distract the animals from those attempting to attract the animal. When hunting game birds, such as ducks, geese, and turkeys, bird decoys which resemble the two or three-dimensional shape and coloration of the desired game bird may be utilized. To achieve a decoy with a three-dimensional shape, solid or compressible decoys may be used. The solid decoys may have a molded outer surface created to mimic the real appearance of the animal being decoyed. Alternatively, collapsible decoys may have an outer fabric surface of the decoy with a printed picture showing a real depiction of an animal in order to mimic the appearance of the animal being decoyed.

Animal decoys may be positioned in the ground through the use of a mounting post. The mounting post may be a stake which may include a perpendicular side piece that allows the user to press with his foot or hand in order to push the mounting post into the ground. The decoy may then be attached to the top of the mounting post.

Once staked to the ground, present decoys are limited in their movement by the mounting post and the way that the decoy is attached to the mounting post. It would be desirable to have a light-weight, portable device for suspending an animal decoy that allows the decoy to move in reaction to the wind, thus making the decoy appear more lifelike and thereby increasing the chances that the decoy will successfully attract the desired animals.

### SUMMARY

A device for suspending an animal decoy comprising a mounting post, which includes a pointed end for insertion into the ground, a blunt end for receiving an attachment, and a side piece extending substantially perpendicular from the mounting post. The device further comprising an extendable rod including a first tubular section with a first end and a second end, wherein the attachment is located on the first end, and on the second end there extends a plurality of flexible tubular sections where the sections have progressively smaller diameters, are slidably disposed in one another, and are in tight frictional engagement with each other such that they remain in any position of extension or retraction in which they are set, and wherein when the extendable rod is in an extended position the plurality of flexible tubular sections are sufficiently flexible that a weight of the animal decoy causes the plurality of tubular sections to bend and position the animal decoy proximate to the mounting post when the mounting post is inserted into the ground. The device may also comprise a line extending from a tip of the flexible tubular section with a smallest diameter and a clipping mechanism configured to attach to the animal decoy.

The device as described above where the weight of the animal decoy is approximately one pound and wherein the plurality of flexible tubular sections of the extendable rod are constructed of carbon fiber. Additionally, the mounting post may be connected to the extendable rod with an elastic retaining cord and the device further comprises an attachable twig and leaf arrangement configured to attach to the extendable rod. According to an embodiment, the device includes a multiple loop structure positioned on the tip of the flexible tubular section with a smallest diameter, to which the line is adjustably attached such that the line extends from the tip of the extendable rod.

According to another embodiment, the extendable rod includes a first tubular section with a first end and a second end, wherein the first end includes a tapered point for insertion into the ground. The second end includes a hollow end from which there extends a plurality of flexible tubular sections where the sections have progressively smaller diameters, are slidably disposed in one another, and are in tight frictional engagement with each other such that they remain in any position of extension or retraction in which they are set, and wherein when the extendable rod is in an extended position the plurality of flexible tubular sections are sufficiently flexible that a predetermined weight of the item in the range of approximately a quarter pound to approximately five pounds causes the plurality of tubular sections to bend and position an item proximate to the ground when the tapered point is inserted into the ground.

### BRIEF DESCRIPTION OF THE DRAWINGS

The detailed description is set forth with reference to the accompanying figures. The use of the same reference numbers in different figures indicates similar or identical items or features.

FIG. 1 illustrates a perspective view of the suspension device suspending a bird decoy, according to an embodiment.

FIG. 2 illustrates a side view of the suspension device in an extended position, according to an embodiment.

FIG. 3 illustrates a side view of the suspension device in a retracted position, according to an embodiment.

### DETAILED DESCRIPTION

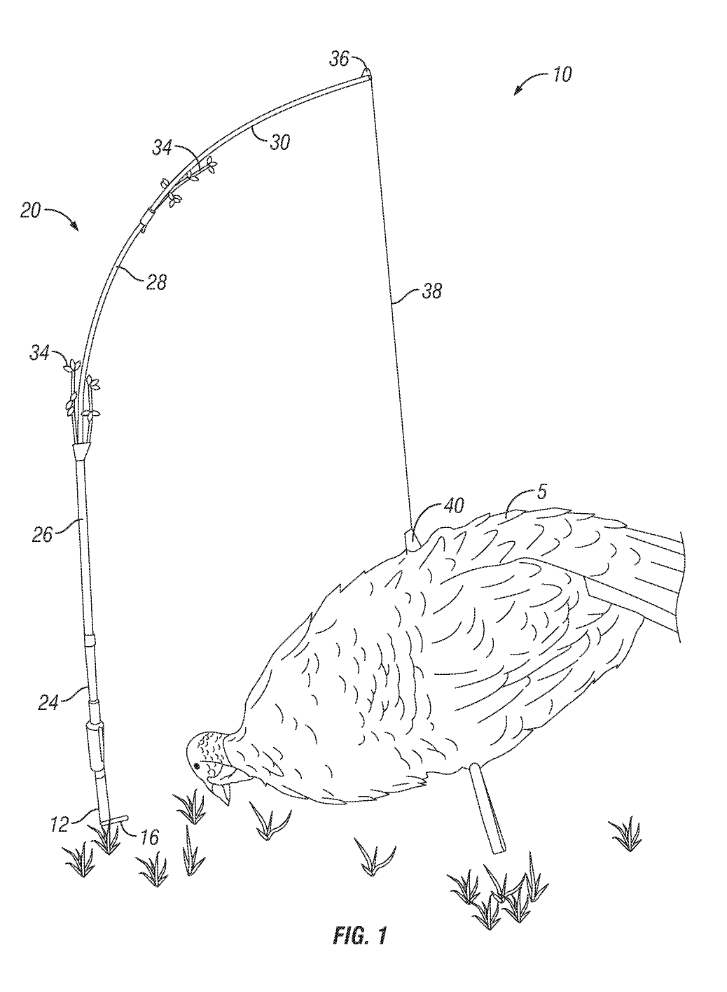

With reference to FIGS. 1, 2, and 3 a decoy suspending device 10 is illustrated. While the invention will generally be described using an embodiment that is suitable for suspending a bird decoy 5, other embodiments may be designed so that they are optimally sized to suspend other animal decoys or objects.

According to an embodiment, the decoy suspending device 10 comprises a mounting post 12 that is shown in a detached position in FIG. 3. The mounting post 12 has a pointed end 14 to aid in inserting the post 12 into the ground. The pointed end 14 may be of any suitable shape, for example, it may be a tapered or angled point that provides a sharp end for insertion into the ground. The post 12 may include a side piece extension 16 which a can also help a user to insert the post 12 into the ground. The side piece 16 may extend from the post 12 at any suitable angle which allows a user to grasp it and apply downward pressure in order to insert the post 12 into the ground. In the preferred embodiment, shown in FIG. 3, the side piece 16 extends perpendicular from the post 12. The post 12 and the side piece 16 may be constructed of any suitable material that is sufficiently strong to withstand repeated insertions into the ground. In preferred embodiments, the post 12 is made of metal and the side piece 16 is permanently attached through a welded connection. Alternatively, the post 12 and side piece 16 could be made of a unitary piece of material, as examples, molded plastic or machined metal could be used.

The mounting post 12 may be connected to an extendable rod 20 via an elastic retaining cord 18. In preferred embodiments, the elastic retaining cord 18 has a first end connected to the post 12 and a second end connected to the extendable rod 20. The elastic retaining cords 18 keeps the mounting post 12 tied to the extendable rod 20, thus preventing the mounting post 12 from being separated or misplaced with respect to the extendable rod 20. The elastic retaining cord 18 is preferably sufficiently elastic so that the extendable rod 20 is removable by hand from the mounting post 12. The elastic retaining cord 18 is preferably able to be nondestructively stretched sufficiently to allow the extendable rod 20 and mounting post 12 to be easily connected, yet retained together when connected. The elastic retaining cord may be made from any durable elastic material. In preferred embodiments, the elastic retaining cord 18 is connected to the mounting post 12 at the side piece 16 and connected to the extendable rod 20 at a point 22 on the first outermost section 24 of the extendable rod 20.

Alternatively, the elastic retaining cord 18 may be attached internally to the mounting post 12 and extendable rod 20, in which case the post 12 and the rod 20 would be constructed as hollow tubular pieces. Other embodiments include a singular piece construction where the post 12 is a part of the extendable rod 20, and the two pieces are not removable from one another.

The extendable rod 20 has a plurality of tubular sections 24, 26, 28, and 30 of progressively smaller diameter slidably disposed in one another. The first outermost section 24 with the largest diameter has an open upper end in which slides the next section 26 with the next smaller diameter. Section 26 has an open end in which slides the next section 28 with a diameter that is smaller than that of section 26. Section 30 has the smallest diameter and slides in section 28. The sections are in tight frictional engagement with each other to remain in any position of extension or retraction in which they are set.

Section 24 includes an open lower end 32 which can be snugly slipped over the top end of the mounting post 12. Any other suitable connection may be used to connect the extendable rod 20 to the post 12, including the top end of the post 12 having an open tubular shape to snugly accept the inserted tubular shape of a closed lower end of section 24.

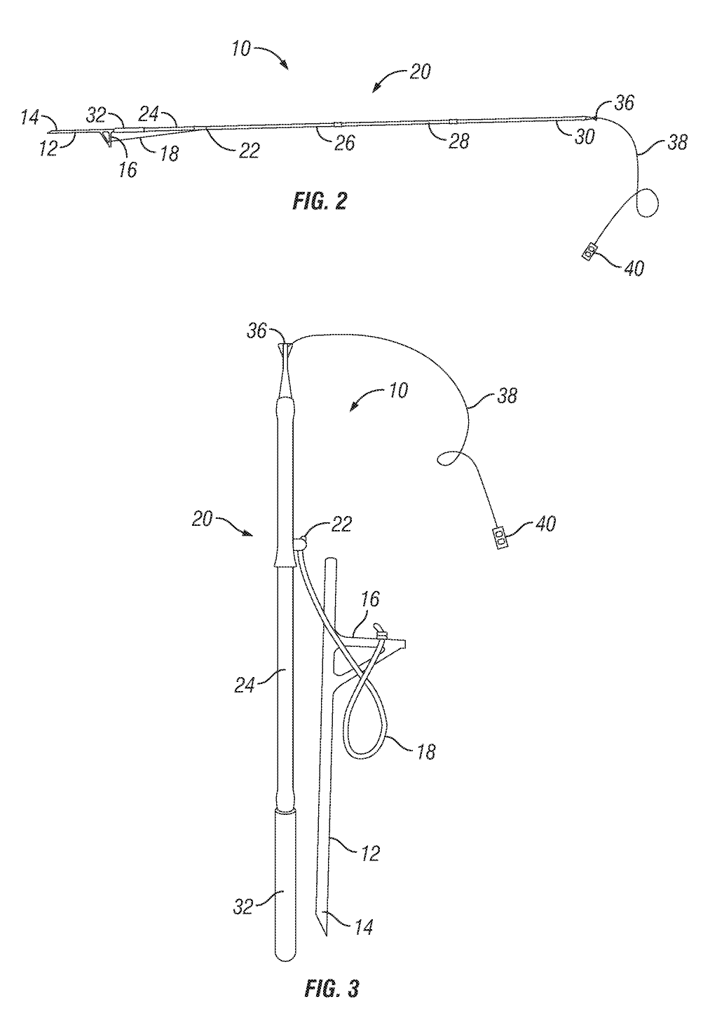

The extendable rod 20 is preferably constructed of a strong, yet flexible material, for example carbon fiber (graphite), fiberglass, a metal or metal alloy, or a combination of these materials. When in the extended or deployed position, as shown in FIGS. 1 and 2, the extendable rod 20 is sufficiently flexible to allow a decoy 5, which has a certain weight, to cause the sections of rod 20, particularly the sections with the smaller diameters 28, 30 to flex and bend. This bend in the extendable rod 20 positions the decoy 5 close to the ground and proximate to the mounting post 12. A decoy of almost any weight may be used, as the characteristics of the extendable rod 20 may be adjusted to accommodate the various sizes and weights of available decoys. As a non-limiting example, a decoy 5 weighing approximately one pound is sufficiently heavy to cause the rod 20 to bend when it is in an extended, or semi-extended position. The embodiment as described, may function with decoys weighing in the range of approximately a quarter pound to approximately five pounds. For decoys in the lower weight range, the extendable rod 20 may be in its fully extended position in order for the desired bend to occur. For decoys in the higher weight range, the extendable rod 20 can be adjusted (extended less) in order to provide less flexibility in the extendable rod 20, thereby still introducing the desired amount of bend in the extendable rod 20.

Due to the tight frictional engagement of the tubular sections 24, 26, 28, and 30 the extendable rod 20 may be deployed in a limitless variation of positions. The rod 20 can be adjusted to permit increased flexibility by fully extending the sections with smaller diameters when the terrain so requires, for instance when the mounting post 12 can be inserted into the ground, in a perpendicular position relative to the ground. Alternatively, in situations where the post 12 may have to be inserted into the ground at an angle, for example, when rocky terrain so requires, the tubular section with a larger diameter 26, which is not as flexible as the sections with the smaller diameters 28, 30, may be fully extended and the sections 28, 30 may be semi-retracted, thus removing some of the bend in the rod 20. This unique customization allows the user to adapt the decoy suspending device 10 to fit the particular environment in which the decoy is suspended.

The extendable rod 20 may include features that help to camouflage the rod 20 in a natural environment. For example, as shown in FIG. 1, extendable rod 20 may include twig and leaf arrangements 34 which give the rod 20 the appearance of being a branch. The twig and leaf arrangements 34 may be constructed of synthetic plant material and can be attached to the extendable rod 20 by any suitable connection. For example, the twig and leaf arrangements 34 may be permanently attached to the extendable rod 20 at the ends of the tubular sections 24, 26, 28, and 30. In such embodiment, the connection of the twig and leaf attachments 34 would not interfere with the functionality of the extendable rod 20. The arrangements 34 may also be removable or selectively attachable.

Other embodiments include having a strap, for example with hook and loop fasteners (Velcro) on opposite ends, where the strap is attachable or permanently connected to the extendable rod 20. Natural leaves and twigs could then be harvested from the environment and attached to the rod 20 with the straps. This, and similar embodiments, would allow the user to ensure that the types of twigs and leaves used to camouflage the rod 20 match the surrounding environment in which the decoy suspending device 10 is deployed.

At the tip of tubular section 30 of the extendable rod 20 is a loop 36 for attaching a line 38. The loop 36 may be permanently attached to the tip of tubular section 30 or may be removable attached by any suitable means. The loop 36 may also be shaped to allow for quick attachment and adjustment of the line 38. For example, the loop 36 may comprise multiple loops where one is inset from the other, similar to a paper-clip structure. This multiple loop structure allows the line 38 to be removed by hand, but exerts enough pressure to keep the line 38 in place once it is set.

The line 38 may be made of any suitable material, with the preferred embodiment using a translucent nylon line. One end of the line 38 may be adjustably attached to loop 36, while the other end is connected to a clipping mechanism 40. The clipping mechanism 40 connects the line 38 to the decoy 5. Clipping mechanism 40, as a non-limiting example, may be a spring biased type clip which acts in a similar manner to a spring loaded clothespin. The jaws of the clipping mechanism 40 are connected at a hinged point and are forced together by spring which allows the jaws to grip and connect the decoy 5 to the wire 38. Extending on the other side of the hinged points opposite the jaws, are tabs that are forced apart by the spring, and which allow a user to compress them to release the jaws from the decoy 5. This preferred embodiment allows for placing the decoy 5 in various positions. As examples, attaching the clipping mechanism 40 to a spot lower on the decoy's back places the decoy 5 in a simulated feeding position, as shown in FIG. 1. Attaching the clipping mechanism 40 higher on the decoy's back simulates a looking or alert position.

A decoy 5 connected to the suspending device 10 exhibits several beneficial behaviors. In an implementation where the decoy 5 is light-weight and weighs approximately a pound and the suspending device 10 has sufficient flex in the tubular section to accommodate such a decoy, the wind will cause the decoy 5 to move side to side. This side to side motion in turn causes the flexible portion of the suspending device 10 to bend in reaction, which results in the decoy 5 exhibiting a bouncing or bobbing movement. The side to side and bouncing motions of the suspended decoy 5 provide an excellent imitation of, for example, a real turkey either looking around or eating. In general, the motion realized by attaching a decoy 5 to the suspending device 10 provides a dramatic increase in the realism of the decoy by introducing simple realistic movement to the decoy 5.

One skilled in the art will realize that a virtually unlimited number of variations to the above descriptions are possible, and that the examples and the accompanying figures are merely to illustrate one or more examples of implementations.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

It will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular embodiments or implementations disclosed, but that such claimed subject matter may also include all embodiments or implementations falling within the scope of the appended claims, and equivalents thereof.

In the detailed description above, numerous specific details are set forth to provide a thorough understanding of claimed subject matter. However, it will be understood by those skilled in the art that claimed subject matter may be practiced without these specific details. In other instances, methods, apparatuses, or systems that would be known by one of ordinary skill have not been described in detail so as not to obscure claimed subject matter.

Reference throughout this specification to “one embodiment,” “an embodiment,” “one implementation,” or “an implementation” may mean that a particular feature, structure, or characteristic described in connection with a particular embodiment or implementation may be included in at least one embodiment or implementation of claimed subject matter. Thus, appearances of the phrase “in one embodiment,” “an embodiment,” “one implementation,” or “an implementation” in various places throughout this specification are not necessarily intended to refer to the same embodiment or implementation, or to any one particular embodiment or implementation described. Furthermore, it is to be understood that particular features, structures, or characteristics described may be combined in various ways in one or more embodiments or implementations. In general, of course, these and other issues may vary with the particular context of usage. Therefore, the particular context of the description or the usage of these terms may provide helpful guidance regarding inferences to be drawn for that context.

What is claimed is:

1. A device for suspending an animal decoy comprising:
a mounting post including a pointed end for insertion into the ground, a blunt end for receiving an attachment, and a side piece extending substantially perpendicular from the mounting post;
an extendable rod including a first tubular section with a first end and a second end, wherein the attachment is located on the first end, and on the second end there extends a plurality of flexible tubular sections where the sections have progressively smaller diameters, are slidably disposed in one another, and are in tight frictional engagement with each other such that they remain in any position of extension or retraction in which they are set, and wherein when the extendable rod is in an extended position the plurality of flexible tubular sections are sufficiently flexible that a weight of the animal decoy causes the plurality of tubular sections to bend and position the animal decoy proximate to the mounting post when the mounting post is inserted into the ground;
a line extending from a tip of the flexible tubular section with a smallest diameter; and
a clipping mechanism configured to attach to the animal decoy.

2. The device of claim 1, wherein the weight of the animal decoy is approximately one pound.

3. The device of claim 1, wherein the plurality of flexible tubular sections of the extendable rod are constructed of carbon fiber.

4. The device of claim 1, wherein the mounting post is connected to the extendable rod with an elastic retaining cord.

5. The device of claim 1 further comprising an attachable twig and leaf arrangement configured to attach to the extendable rod.

6. The device of claim 1, wherein the flexible tubular section with a smallest diameter includes a multiple loop structure positioned on the tip to which the line is adjustably attached such that the line extends from the tip.

7. A device for suspending an item comprising:
an extendable rod including a first tubular section with a first end and a second end, wherein the first end includes a tapered point for insertion into the ground, and the second end includes a hollow end from which there extends a plurality of flexible tubular sections where the sections have progressively smaller diameters, are slidably disposed in one another, and are in tight frictional engagement with each other such that they remain in any position of extension or retraction in which they are set, and wherein when the extendable rod is in an extended position the plurality of flexible tubular sections are sufficiently flexible that a predetermined weight of the item causes the plurality of tubular sections to bend and position the item proximate to the ground when the tapered point is inserted into the ground;
a line extending from a tip of the flexible tubular section with a smallest diameter; and
a clip connected to the line, the clip configured to attach to the item.

8. The device of claim 7 wherein the item is an animal decoy.

9. The device of claim 8, wherein the predetermined weight of the animal decoy ranges from approximately a quarter pound to approximately five pounds.

10. The device of claim 7, wherein the plurality of flexible tubular sections of the extendable rod are constructed of carbon fiber.

11. The device of claim 7, further comprising an attachable twig and leaf arrangement configured to attach to the extendable rod.

12. The device of claim 7, wherein the flexible tubular section with a smallest diameter includes a multiple loop structure positioned on the tip to which the line is adjustably attached such that the line extends from the tip.

13. A device for suspending a decoy comprising:
an extendable rod including a first tubular section with a first end and a second end, wherein the first end is configured to connect to a mounting post and the second end includes an open end from which extends a plurality of flexible tubular sections where the sections have progressively smaller diameters, are slidably disposed in one another, and are in tight frictional engagement with each other such that they remain in any position of extension or retraction in which they are set, and wherein when the extendable rod is in an extended position the plurality of flexible tubular sections are sufficiently flexible that a weight of the decoy causes the plurality of tubular sections to bend and position the decoy proximate to the ground when the extendable rod is in a deployed position.

14. The device of claim 13, further comprising:
the mounting post connected to the first end, wherein the mounting post includes a pointed end for insertion into the ground opposite a receiving end for connecting to the first end of the extendable rod.

15. The device of claim 13, further comprising:
a line extending from a tip of the flexible tubular section with a smallest diameter; and
a clip connected to the line, the clip configured to attach to the decoy.

16. The device of claim 13, wherein the weight of the decoy is approximately one pound.

17. The device of claim 13, wherein the plurality of flexible tubular sections of the extendable rod are constructed of carbon fiber.

18. The device of claim 13, further comprising an attachable twig and leaf arrangement configured to attach to the extendable rod.

19. The device of claim 13, wherein the flexible tubular section with a smallest diameter includes a multiple loop structure positioned on the tip to which the line is adjustably attached such that the line extends from the tip.
